(19) United States
(12) Patent Application Publication
(10) Pub. No.: US 2024/0072268 A1
(43) Pub. Date: Feb. 29, 2024

(54) FUEL CELL SYSTEM

(71) Applicant: PLUG POWER INC., Latham, NY (US)

(72) Inventor: Anthony REFFELT, Halfmoon, NY (US)

(73) Assignee: PLUG POWER INC., Latham, NY (US)

(21) Appl. No.: 17/821,560

(22) Filed: Aug. 23, 2022

(51) Int. Cl. H01M 8/0256; H01M 8/04537; H01M 8/1004; H01M 8/2465

(52) U.S. Cl. CPC H01M 8/0256; H01M 8/04537; H01M 8/1004; H01M 8/2465; H01M 8/0269

(57) ABSTRACT

A connector system for use in connecting a fuel cell plate to an electrical device includes first arms elastically deformable toward each other to allow an insertion of the first arms into a first slot of a fuel cell plate and elastically returnable to provide a force against a surface of the fuel cell plate to hold the arms against the fuel cell plate, and second arms elastically deformable toward each other to allow an insertion of the second arms into a second slot of an electrical device and elastically returnable to provide a force against a surface of the electrical device to hold the arms against the electrical device. The first arms are connected to the second arms at intersecting points allowing movement of the first arms relative to the second arms.

This application is also related to U.S. patent application Ser. No. 17/817,400 filed on Aug. 4, 2022, entitled “FUEL CELL INFORMATION MONITOR AND DATA TRANSFER”, the disclosure of which is incorporated by reference herein.

This application is also related to U.S. patent application Ser. No. 17/663,097 filed on May 12, 2022, entitled “INTEGRATED CIRCUIT FOR DIAGNOSTICS”, the disclosure of which is incorporated by reference herein.

### TECHNICAL FIELD

The present invention relates, generally, to methods and systems for monitoring a fuel cell stack, and more particularly, to systems and methods for monitoring a fuel cell stack to for variations in electrical output and functioning of fuel cells of a fuel cell stack system.

### BACKGROUND OF THE INVENTION

Fuel cells electrochemically convert fuels and oxidants to electricity and heat and can be categorized according to the type of electrolyte (e.g., solid oxide, molten carbonate, alkaline, phosphoric acid or solid polymer) used to accommodate ion transfer during operation. Moreover, fuel cell assemblies can be employed in many (e.g., automotive to aerospace to industrial to residential) environments, for multiple applications.

A Proton Exchange Membrane (hereinafter “PEM”) fuel cell converts the chemical energy of fuels, such as hydrogen, and oxidants, such as air, directly into electrical energy. The PEM is a sold polymer electrolyte that permits the passage of protons (i.e., H+ ions) from the “anode” side of the fuel cell to the “cathode” side of the fuel cell while preventing passage therethrough of reactant fluids (e.g., hydrogen and air gases). The Membrane Electrode Assembly (hereinafter “MEA”) is placed between two electrically conductive plates, each of which has a flow passage to direct the fuel to the anode side and oxidant to the cathode side of the PEM.

Two or more fuel cells may be connected together to increase the overall power output of the assembly. Generally, the cells are connected in series, wherein one side of a plate serves as an anode plate for one cell and the other side of the plate is the cathode plate for the adjacent cell. These are commonly referred to as bipolar plates (hereinafter “BPP”). Alternately, the anode plate of one cell is electrically connected to the separate cathode plate of an adjacent cell. Commonly these two plates are connected back to back and are often bonded together (e.g., bonded by adhesive, weld, or polymer). This bonded pair becomes as one, also commonly called a bipolar plate, since anode and cathode plates represent the positive and negative poles, electrically. Such a series of connected multiple fuel cells is referred to as a fuel cell stack. The stack typically includes means for directing the fuel and the oxidant to the anode and cathode flow field channels, respectively. The stack usually includes a means for directing a coolant fluid to interior channels within the stack to absorb heat generated by the exothermic reaction of hydrogen and oxygen within the fuel cells. The stack generally includes means for exhausting the excess fuel and oxidant gases, as well as product water.

The stack also includes an endplate, insulators, membrane electrode assemblies, gaskets, separator plates, electrical connectors and collector plates, among other components, that are integrated together to form the working stack designed to produce electricity. The different plates may be abutted against each other and connected to each other to facilitate the performance of particular functions.

As indicated, a fuel cell stack includes multiple connected fuel cells. Individual cell voltage monitoring is critical for system control and durability. For example, a cell with low performance can cause numerous failure mechanisms if undetected. Large stacks of fuel cells may sometimes include hundreds of cells, and cell voltage of such cells is currently detected with individual wires where voltage signals are multiplexed through integrated circuits. Managing these wires and their connections is tedious during an assembly of the multiple fuel cells into a fuel cell stack, and there are significant voltage differentials that must be managed inside electronics. The assembly of this system of cell voltage monitor significantly increases a build time and cost of a fuel cell stack.

A cell voltage monitoring pickup card may include multiple wires connected to multiple fuel cell plates to allow an electrical connection between such plates and a scanner card. Such a scanner card may be connected to a data processor or controller for measuring a voltage between such plates, for example.

Such a cell voltage monitoring pickup card may include a plurality of wire loops extending away from a printed circuit board such that the loops may contact fuel cell plates such that the voltage between such plates may be monitored. When connected to a fuel cell plate, a pickup card may be exposed to a high humidity environment along with being subject to shocks and vibrations if the fuel cell itself is used in a mobile application. The shocks and vibrations can cause a disconnection of the pickup card relative to a fuel cell plate thereby interrupting any monitoring (e.g., of cell voltages) that may be underway. Thus, it is useful if any connection between a fuel cell plate and pick up card is resistant to separation. It is further advantageous if such a pickup card can be easily connected to a fuel cell plate for easy setup of such monitoring.

Thus, there is a need for improved systems and methods for monitoring an operation of fuel cells of an assembled fuel cell system.

### SUMMARY OF THE INVENTION

The present invention provides, in a first aspect, a connector system for use in connecting a fuel cell plate to an electrical device which includes first arms elastically deformable toward each other to allow an insertion of the first arms into a first slot of a fuel cell plate and elastically returnable to provide a force against a surface of the fuel cell plate to hold the arms against the fuel cell plate, and second arms elastically deformable toward each other to allow an insertion of the second arms into a second slot of an electrical device and elastically returnable to provide a force against a surface of the electrical device to hold the arms against the electrical device. The first arms are connected to the second arms at intersecting points allowing movement of the first arms relative to the second arms.

The present invention provides, in a second aspect, a method for connecting a fuel cell plate to an electrical device which includes elastically deforming the first arms of the connector toward each other, inserting the first arms into a first slot of a fuel cell plate and releasing the first arms to elastically return the first arms to engage first surfaces of the fuel cell plate to connect the first arms to the fuel cell plate. The second arms of the connector are elastically deformed toward each other, the arms are inserted into a second slot of an electrical device to electrically connect the fuel cell plate to the electrical device and the second arms are released to elastically return the second arms to engage second surfaces of the electrical device to connect the second arms to the electrical device.

The present invention provides, in a third aspect, a fuel cell system which includes a membrane electrode assembly, a first fuel cell separator and a second fuel cell separator on opposite sides of the membrane electrode assembly. A connector connects the first fuel cell plate separator and an electrical device connected to the second fuel cell plate separator. The connector includes a first end elastically deformable and received in a first slot of the first plate separator, such that the first end contacts first slot bounding surfaces bounding the first slot in response to an elastic return of the first end after the connector is elastically deformed to be received in the slot. The second connector is held in the first slot by a force provided by the first end against the first slot bounding surfaces by the elastic return. The connector includes a second end elastically deformable and received in a second slot of the electrical device, such that the second end contacts the second electrical device in response to a second elastic return of the second end after the connector is elastically deformed to be received in the second slot. The connector is held in the second slot by a force provided by the second end against the electrical device by the second elastic return.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a block diagram of a fuel cell system in accordance with the invention;

FIG. 2 is a perspective view of a portion of a fuel cell of the fuel cell system of FIG. 1;

FIG. 3 is a block diagram view of a voltage sensor connected to opposing bipolar plates of the fuel cell system of FIG. 1;

FIG. 4 is a side cross-sectional view of a connector being received in a slot of a fuel cell plate of the system of FIG. 3;

FIG. 5 is a top view of the connector being received in the slot of the fuel cell of FIG. 4;

FIG. 6 is a top plan view of a connector for use in connecting a fuel cell plate and an electrical device in accordance with the present invention;

FIG. 7 is a side view of the connector of FIG. 6;

FIG. 8 is side cross-sectional view of a slot in a fuel cell plate in accordance with the present invention for receiving a tab of the connector of FIG. 6;

FIG. 9 is a top plan view of the connector of FIG. 6 being received in a printed circuit board in accordance with the present invention;

FIG. 10 is a top plan view of a connector for use in connecting a fuel cell plate and an electrical device in accordance with the present invention;

FIG. 11 is a side view of the connector of FIG. 10;

FIG. 12 is a top plan view of a connector for use in connecting a fuel cell plate and an electrical device in accordance with the present invention;

FIG. 13 is a side view of the connector of FIG. 12;

FIG. 14 is a top plan view of a connector for use in connecting a fuel cell plate and an electrical device in accordance with the present invention;

FIG. 15 is a side view of the connector of FIG. 14;

FIG. 16 is a top plan view of the connector of FIG. 14 being received in a slot of a fuel cell plate and a slot of a pickup card;

FIG. 17 is a side cross-sectional view of a portion of the connector and fuel cell plate of FIG. 16 showing the connector being received in a recess of the slot of the fuel cell plate;

FIG. 18 is a top plan view of a connector for use in connecting a fuel cell plate and an electrical device in accordance with the present invention;

FIG. 19 is a side view of the connector of FIG. 18;

FIG. 20 is a top plan view of a connector for use in connecting a fuel cell plate and an electrical device in accordance with the present invention;

FIG. 21 is a side view of the connector of FIG. 20;

FIG. 22 is a top plan view of a connector for use in connecting a fuel cell plate and an electrical device in accordance with the present invention;

FIG. 23 is a side view of the connector of FIG. 22;

FIG. 24 is a top plane view of a connector for use in connecting a fuel cell plate and an electrical device in accordance with the present invention; and

FIG. 25 is a side view of the connector of FIG. 24.

### DETAILED DESCRIPTION OF THE INVENTION

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

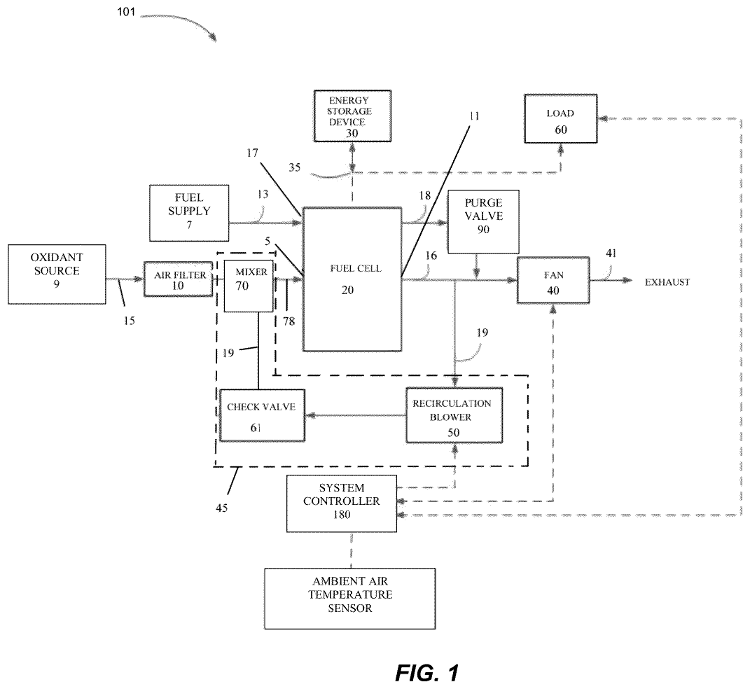

Thus, all the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In accordance with the principals of the present invention, fuel cell systems and methods for manufacturing a fuel cell stack are provided. In an example depicted in FIG. 1, a fuel cell system 101 is referred to as the assembled, or complete, system which functionally together with all parts thereof produces electricity and typically includes a fuel cell stack 20 and an energy storage device 30. The fuel cell is supplied with a fuel 13, for example, hydrogen, through a fuel inlet 17. Excess fuel 18 may be exhausted from the fuel cell through a purge valve 90 and may be diluted by a fan 40. In one example, fuel cell stack 20 may have an open cathode architecture of a PEM fuel cell, and combined oxidant and coolant, for example, air, may enter through an inlet air filter 10 coupled to an inlet 5 of fuel cell stack 20. Excess coolant/oxidant and heat may be exhausted from a fuel cell cathode of fuel cell stack 20 through an outlet 11 to fan 40 which may exhaust the coolant/oxidant and/or excess fuel to a waste exhaust 41, such as the ambient atmosphere. The fuel and coolant/oxidant may be supplied by a fuel supply 7 and an oxidant source 9 (e.g., air), respectively, and other components of a balance of plant, which may include compressors, pumps, valves, fans, electrical connections and sensors.

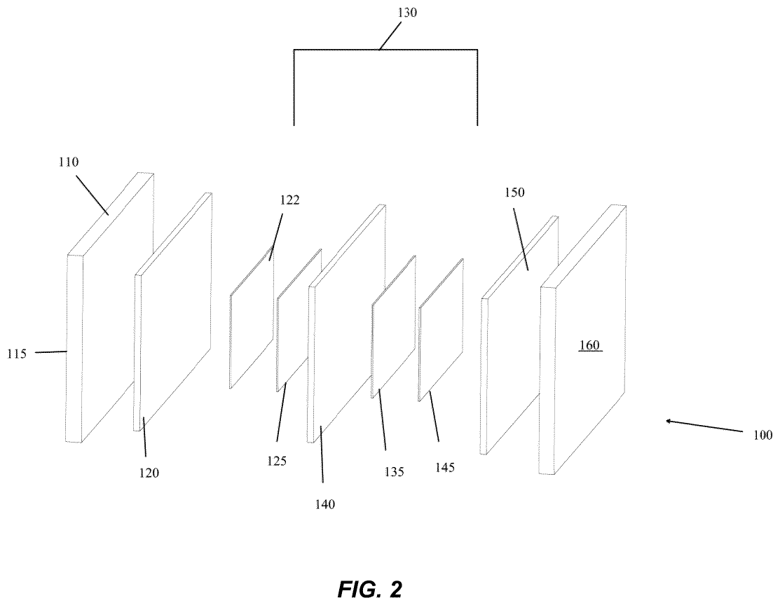

FIG. 2 depicts a schematic exploded view of an internal subassembly 100 of fuel cell stack 20 of FIG. 1 including a cathodic plate separator 110 at an outer end 115 and a plate separator seal 120 on an inner side thereof. A membrane electrode assembly (MEA) 130 is located between seal 120 and a second plate separator seal 150. An anode plate separator 160 is on a second end 165 of subassembly 100.

MEA 130 includes a membrane 140 (e.g., an ion conducting membrane) between a cathode side catalyst layer 125 and an anode side catalyst layer 135. A cathode side gas diffusion layer (GDL) 122 is located between cathode side catalyst layer 125 of the membrane electrode assembly and plate separator 110. An anode side gas diffusion layer 145 is located between anode side catalyst layer 135 of the membrane electrode assembly and plate separator 160. Seal 120 and seal 150 may be received in a channel of on an inner side of plate separator 110 and plate separator 160, respectively. In another example, such seals may be injection molded around an MEA (e.g., MEA 130) or another fuel cell component.

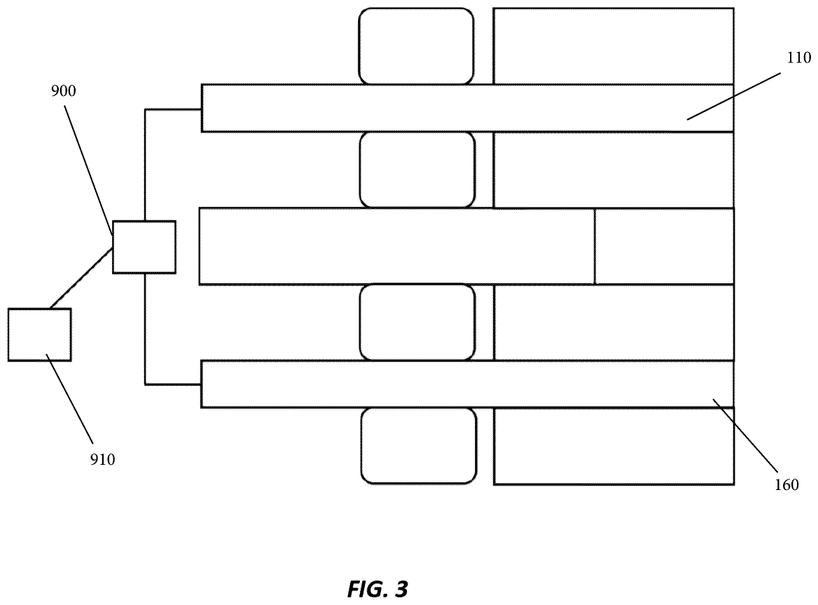

In an example depicted in FIG. 3, a voltage sensor 900 may be electrically connected to opposing bipolar plates 102, e.g., plate separator 110 and plate separator 160 of subassembly 100 of fuel cell stack 20. Sensor 900 may detect and/or measure a voltage potential between plate separator 110 and plate separator 160.

As indicated above, a cell voltage monitoring pickup card may include multiple electrical and/or mechanical connectors to connect to various portions of a fuel cell stack (e.g., fuel cell stack 20). Such connectors between the cards and plates may allow an electrical connection between such plates and a scanner card-which may be connected to a data processor or controller for measuring a voltage between such plates, for example.

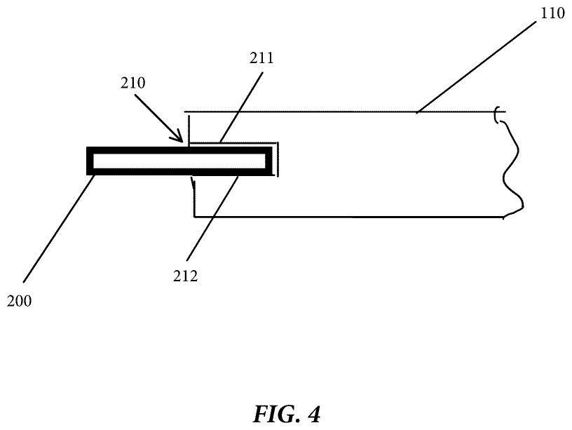

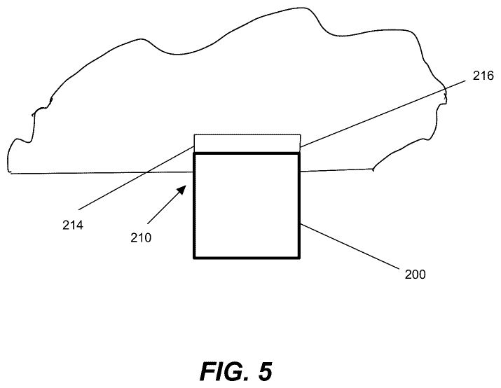

Fuel cell plates (e.g., plate separator 110 and plate separator 160) may include slots for receiving electrical connectors to allow a measurement of a voltage or potential between fuel cell plates in a fuel cell stack (e.g., fuel cell stack 20). FIGS. 4-5 depict a connector 200 being received in a slot 210 of plate separator 110 such that connector 200 makes an electric connection with plate separator 110 in block diagram form from a side and cross-sectional top view, respectively. Similarly, plate separator 160 (FIG. 3) may have a slot (not shown) for receiving a second connector to allow a voltage measurement between plate separator 110 and plate separator 160. Slot 210 may include vertical slot bounding surfaces 211 and 212, and lateral slot bounding surfaces 214 and 216. The portions of the plate separators bounding the slots and the electrical connectors (e.g., connector 200) may be formed of, or otherwise include an electrically conductive material, such as any copper, silver, stainless steel, nickel, or similar conductive material or alloy, typically plated with an inert material, such as gold to prevent oxidation and corrosion.

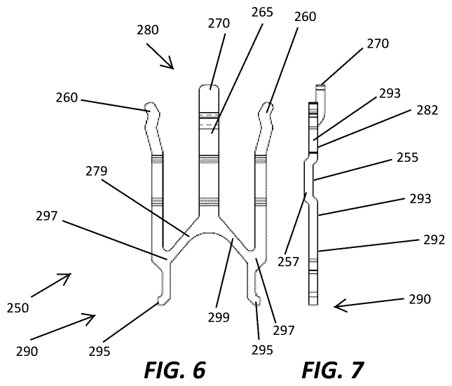

FIGS. 6-7 depict a connector 250 that may be received in a slot of a fuel cell plate, such as that described above relative to connector 200 and plate separator 110. Connector 250 may include outer arms 260 and a center arm 265 at a first end 280 of connector 250. A second end 290 may be at an opposite longitudinal end of connector 250 relative to first end 280. Second end may include connecting arms 295.

Connector 250 may be formed of a stamped sheet metal (e.g., Copper, Nickel, Stainless Steel, Titanium, Monel, Inconel, or other alloys of such materials therein that are both conductive and inert whether through plating or passive formation of protection that does not impede electrical operation or solderability). Outer arms 260 may be elastically deformable (e.g., via hand manipulation by a user) toward one another and center arm 265 such that outer arms 260 may be received in a slot (e.g., slot 210) and may elastically return to contact lateral slot bounding surfaces (e.g., lateral slot bounding surfaces 214, 216 (FIG. 5)) such that a contact of outer arms 260 and such lateral slot bounding surfaces may inhibit a removal of connector 250 from the slot. Electrical contact may be made between a connector (e.g., connector 250) and lateral or vertical bounding surfaces (e.g., lateral slot bounding surfaces 214, 216 and vertical slot bounding surfaces 211, 212) of such a slot to allow a voltage measurement as described above.

As depicted in FIG. 7, connector 250 may have a stepped shape such that a proximal portion 292 adjacent second end 290 and a distal portion 282 adjacent first end 280 may have opposing linear surfaces (e.g., a top and bottom surface) which are aligned such that the proximal portion 292 and distal portion 282 are in a same plane. A middle tab or portion 255 may be stepped relative to a proximal portion 292 and distal portion 282 such that opposing linear surfaces (e.g., a top and bottom surface) are offset in longitudinal alignment relative to opposite linear surfaces of proximal portion 292 and distal portion 282. The offset nature of middle portion 255 provides a spring like effect when connector 250 is received in a slot (e.g., slot 210) having a vertical dimension smaller than a combined dimension between a bottom surface 257 of middle portion 255 and top surfaces 293 of proximal portion 292 and distal portion 282 in a transverse direction about perpendicular to a longitudinal dimension of connector 250. For example, when connector 250 is received in a slot (e.g., slot 210), middle portion 255 may be deformed in a direction toward a connecting axis connecting axes of proximate portion 292 and distal portion 282 in a direction transverse to the longitudinal dimension of connector 250. Such deformation may be elastic and may provide a frictional fit in the slot (e.g., slot 210) to inhibit a removal of connector 250 from the slot.

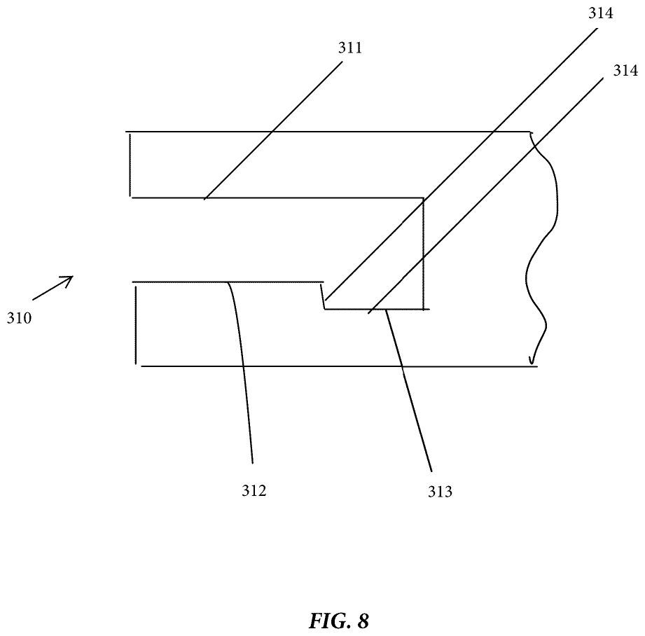

Further, connector 250 may include an end tab 270 (e.g., of center arm 265) at a distal end of distal portion 282 which may extend upwardly (e.g., in a direction transverse to the longitudinal dimension of connector 250) and may extend further distally than a remainder of distal portion 282. Surfaces bounding a slot (e.g., slot 210) may include a recess for receiving tab 270. A slot (e.g., slot 210) may receive, and connector 250 may be dimensioned such that, tab 270 may be received therein, and may be elastically deformed such that, tab 270 may elastically return to be received in the recess of the slot. After being received in the recess, tab 270 may contact surfaces bounding the recess such that these surfaces contacting the tab may inhibit removal of the tab from the recess. In an example depicted in FIG. 8, a slot 310 of a fuel cell plate (e.g., plate separator 110) similar to slot 210, may include a top slot bounding surface 311 and a bottom slot bounding surface 312. Bottom slot bounding surface 312 may include a recess 313 at a distal end thereof which may be configured (shaped and dimension) to receive a tab (e.g., tab 270) on a distal end of a connector, such as connector 250. For example, connector 250 may be inserted into slot 310 such that middle portion 255 may elastically deform in a direction transverse to a longitudinal dimension of the slot and tab 270 make elastically deform upwardly while in contact with top slot bounding surface 311 and bottom slot bounding surface 312 until tab 270 reaches recess 313—at which time tab 270 may elastically return to be received in recess 313 bounded by surfaces 314 of bottom slot bounding surface 312 and thereby provide a frictional fit inhibiting backward movement of connector 250 out of slot 310.

Center arm 265 may extend in a linear direction between outer arms 260 and have a stepped shape, as do outer arms 260, as depicted in FIG. 7. Connecting arms 295 may extend to connecting intersections 297 where outer arms 260 and inner connecting members 299 converge. Inner connecting members 299 connect outer arms 260 to center arm 265.

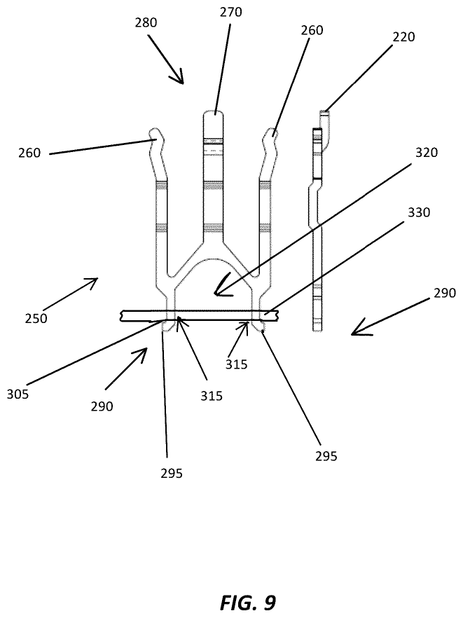

Connecting arms 295 may be elastically deformable (e.g., via hand manipulation by a user) toward one another such that connecting arms 295 may be received in a card slot 320 bounded by surfaces of a pickup card 330 as depicted in FIG. 9, for example. Such elastic deformation may be relative to pivot points at connecting intersections 297, or about points on inner connecting members 299, for example. Further, outer arms 260 may be elastically deformed toward each other, as indicated above, with such deformation being about pivot points at connecting intersections 297, for example.

For example, arms 295 may be deformed toward each other (e.g., relative to pivot points at connecting intersections 297) to allow the arms to be received in such a slot (e.g., slot 320) and the arms may be released such that they elastically return and contact interior surfaces (e.g., interior surfaces 315) and/or a back surface (e.g., a back surface 305) of the card bounding the slot, such that the arms (e.g., connecting arms 295) may inhibit separation of connector 250 from the card. For example, the connecting arms may extend laterally or vertically past a side of the opening or slot such that the arms may contact the interior and exterior rear surfaces of the card to inhibit the separation of the connector 250 from the card.

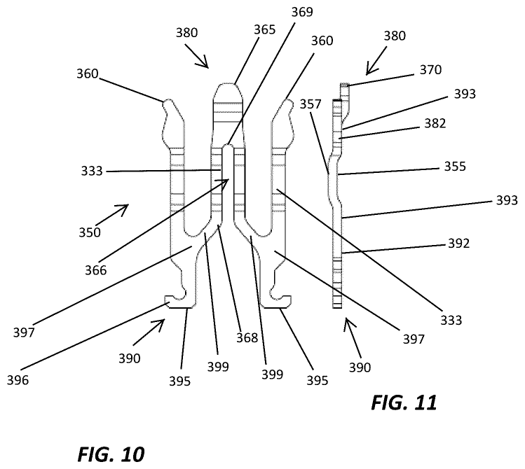

In an example, a connector 350 configured (e.g., shaped and dimensioned) to be received in a slot of a fuel cell plate, such as that described above relative to connector 250 and plate separator 110, is depicted in FIGS. 10-11. Connector 350 may include outer arms 360 and a center arm 365 at a first end 380 of connector 350. A second or proximal end 390 may be at an opposite longitudinal end of connector 350 relative to first or distal end 380. Second end 390 may include connecting arms 395.

Connector 350 may be formed of a stamped sheet metal, for example. Outer arms 360 may be elastically deformable (e.g., via hand manipulation by a user) toward one another and center arm 365 such that outer arms 360 may be received in a slot (e.g., slot 210) and may elastically return to contact lateral slot bounding surfaces (e.g., lateral slot bounding surfaces 214, 216 (FIG. 5)) such that a contact of outer arms 360 and such lateral slot bounding surfaces may inhibit a removal of connector 350 from the slot. Electrical contact may be made between a connector (e.g., connector 350) and lateral or vertical bounding surfaces (e.g., lateral slot bounding surfaces 214, 216 and vertical slot bounding surfaces 211, 212) of such a slot to allow a voltage measurement (e.g., via sensor 900), as described above.

As depicted in FIG. 11 connector 350 may have a stepped shape such that a proximal portion 392 adjacent second end 390 and a distal portion 382 adjacent first end 380 may have opposing linear surfaces (e.g., a top and bottom surface) and axes which are aligned such that the proximal portion 392 and distal portion 382 are in a same plane. A middle tab or portion 355 may be stepped relative to a proximal portion 392 and distal portion 382 such that opposing linear surfaces (e.g., a top and bottom surface) are offset in longitudinal alignment relative to opposite linear surfaces of proximal portion 392 and distal portion 382. As described above relative to connector 250. The offset nature of middle portion 355 provides a spring like effect when connector 350 is received in a slot (e.g., slot 210) having a vertical dimension smaller than a combined dimension between a bottom surface 357 of middle portion 355 and top surfaces 393 of proximal portion 392 and distal portion 382 in a transverse direction about perpendicular to the longitudinal dimension of connector 350. For example, when connector 350 is received in a slot (e.g., slot 210). Middle portion 355 may be deformed toward proximal portion 392 and distal portion 382 in a direction transverse to the longitudinal dimension of connector 350. Such deformation may be elastic and may provide a frictional fit in the slot (e.g., slot 210) to inhibit a removal of connector 350 from the slot.

Further, connector 350 may include an end tab 370 (e.g., of center arm 365) at a distal end of distal portion 382 which may extend upwardly or downwardly (e.g., in a direction transverse to the longitudinal dimension of connector 350) and may extend further distally than a remainder of distal portion 382. Surfaces bounding a slot (e.g., slot 210) may include a recess for receiving tab 370. A slot (e.g., slot 210 or 310) may receive, and connector 350 may be dimensioned such that, tab 370 may be received therein, and may be elastically deformed such that, tab 370 may elastically return to be received in the recess (e.g., recess 313) of the slot. After being received in the recess, tab 370 may contact surfaces (e.g., surfaces 314) bounding the recess such that these surfaces contacting the tab may inhibit removal of the tab from the recess. For example, as described above relative to connector 250, connector 350 could be inserted into slot 310 (FIG. 8) such that middle portion 355 may elastically deform in a direction transverse to a longitudinal dimension of the slot and tab 370 make elastically deform upwardly (i.e., downwardly according to the orientation of slot 310 as depicted in FIG. 8) while in contact with top slot bounding surface 311 and bottom slot bounding surface 312 until tab 370 reaches recess 313—at which time tab 370 may elastically return to be received in recess 313 bounded by surfaces 314 of bottom slot bounding surface 312 and thereby provide a frictional fit inhibiting backward movement of connector 350 out of slot 310.

Center arm 365 may extend in a linear direction between outer arms 360 and have a stepped shape, as does outer arms 360, as depicted in FIG. 11. Center arm 365 may further include a center groove 366 having a longitudinal axis aligned with a longitudinal axis of connector 350. Groove 366 may extend from a proximal end 368 of center arm 365 toward first end 380 and ending at a distal groove end 369 proximal of first end 380 and tab 370. Groove 366 may be bounded by center arm portions 333 of center arm 365.

Connecting arms 395 may extend to connecting intersections 297 where outer arms 360 and inner connecting members 399 converge. Inner connecting members 299 may connect outer arms 260 to center arm 365.

Groove 366 may allow a deformation of center arm portions 333 into groove 366 and therefore portions of connector 350 attached to center arm portions 333 may be movable due to the presence of a space (e.g., groove 366) and an elastically returnable nature of connector 350 allowing arm portions 333 when moved toward each other about a pivot point (e.g., at distal groove end 369) to act as a spring and elastically return toward an original position (e.g., as depicted in FIG. 10).

Connecting arms 395 may be elastically deformable (e.g., via hand manipulation by a user) toward one another such that connecting arms 395 may be received in a card slot 320 bounded by surfaces of a pickup card 330 as described above and depicted in FIG. 9 relative to connector 250, for example. Such elastic deformation may be relative to pivot points at connecting intersections 397, or about points on inner connecting members 399, for example. Further, center arm portions 333 may move toward each other into groove 333 as described above to allow connecting arms 395 to be received in card slot 320, for example. An elastic return of arm portions 333 may hold connecting arms against sides (not shown but similar to lateral slot bounding surfaces 214 and 216) of such a card slot (e.g., card slot 320) to inhibit a separation of connector 350 from such a card.

For example, arms 395 may be deformed toward each other (e.g., relative to pivot points at connecting intersections 397 and/or resulting from arm portions deforming into groove 333) to allow the arms to be received in such a slot (e.g., slot 310) and the arms may be released such that they elastically return and contact interior surfaces (e.g., interior surfaces 315) and/or a back surface (e.g., a back surface 305) of the card bounding the slot, such that the arms (e.g., connecting arms 395) may inhibit separation of connector 350 from the card. For example, the connecting arms may extend laterally or vertically past a side of the opening such that the arms may contact the interior surfaces of the card to inhibit the separation of the connector (e.g., connector 350) from the card. Arms 395 may further include prongs 396 curved to inhibit a retraction of connector 350 from a card (e.g., card 330).

As described above, outer arms 360 may be elastically deformed toward each other to allow the arms to be received in a slot (e.g., slot 210, slot 310) with such deformation being about pivot points at connecting intersections 397, for example. Further, such outer arms (e.g., outer arms 360) may be connected to center arm portions 333 via connecting intersections 397 such that the outer arms may be moved toward each other due to a further separation of inner arms 333 from each other (and an increase in a size of groove 366) about a pivot point (e.g., at distal groove end 369).

As described, groove 366 of center arm 365 of connector 350 may allow a deformation of center arm portions 333 toward or away from each other thereby decreasing or increasing a size of groove 366 and allowing a deformation of outer arms 360 and arms 395 to allow a connection of the connector to a fuel cell plate and pick up card. As described, a stepped configuration of the connector (e.g., an axial misalignment of outer surfaces of middle portion 355 relative to opposite outside linear surfaces of proximal portion 392 and distal portion 382) may allow a vertical friction fit of the connector in a slot (e.g., slot 210, 310) while a tab (e.g., tab 370) may be received in a recess (e.g., recess 313) of an inner surface of such a slot to create an interference fit with such friction fit and/or interference fit inhibiting a separation of the connector and a pick up card connected to such connector to a fuel cell to facilitate an electrical connection.

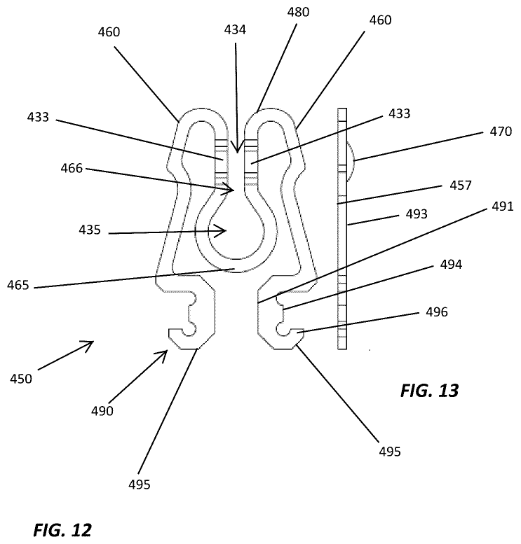

FIGS. 12-17 depict connectors formed of same materials and having shapes similar to connectors 250 and 350 described above and with distal ends engageable with a fuel cell slot (e.g., slot 210 of plate separator 110) and center arms having grooves to allow deformation of center arms into such grooves to minimize a size thereof and away from such grooves to increase a size thereof with such deformation facilitating an insertion and retention of such distal ends in such fuel cell slots (e.g., slot 210 of plate separator 110) and an insertion and retention of proximal ends thereof in slots (e.g., card slot 320) of pick up cards (e.g., pick up card 330).

FIGS. 12-13 depicts a connector 450 having outer arms 460 and a center arm 465 extending from a first end 480 of connector 450. A second end 490 may be at an opposite longitudinal end of connector 450 relative to first end 480. Second end 490 may include connecting arms 495 which may include a leg portion 491 with a flat external surface 494 and a hooked or pronged portion 496 at a proximal end thereof but extending distally.

Center arm 465 may extend in a linear direction between outer arms 460 from first end 480 and include a center groove 466 having a longitudinal axis aligned with a longitudinal axis of connector 450. Groove 466 may be bounded by center arm portions 433 of center arm 465. Center arm portions 433 may be connected to each other, and may be configured (e.g., shaped and dimensioned), such that groove 433 includes a linear portion 434 and a rounded portion 435. A rounded shape of center arm 465 bounding rounded portion 435 may adjust a stress concentration, as compared to a comparable linear structure, due to bending and reduces a potential for cracking in some less elastic materials. Additionally, the larger geometry of center arm 465 compared to a linear embodiment allows for more contact surface area and stability, e.g., with a slot, such as slot 320.

As depicted in FIGS. 12-13, connector 450 may have opposing linear surfaces (e.g., a top surface 493 and a bottom surface 457) which are aligned such that connector 450 is within a same plane except for a tab 470 (e.g., on center arm 433) that may project upwardly (e.g., in a direction transverse to a longitudinal axis of connector 450). Tab 470 may have an arched shape and may cause a frictional engagement with surfaces bounding a slot (e.g., slot 210, 310) of a fuel cell plate (e.g., plate separator 110) to inhibit a separation of connector 450 from such a fuel cell plate, as described above.

Connecting arms 495 may be deformable toward each other, as described above relative to connecting arms 293, 395, to allow an insertion thereof into a slot (e.g., slot 320) for connection to an electrical device, such as a pick up card. Such elastic deformation may be about outer arms 460 (e.g., each portion of first end 480) along with a deformation of center arm portions 433 into groove 466 to form a compound pivot action.

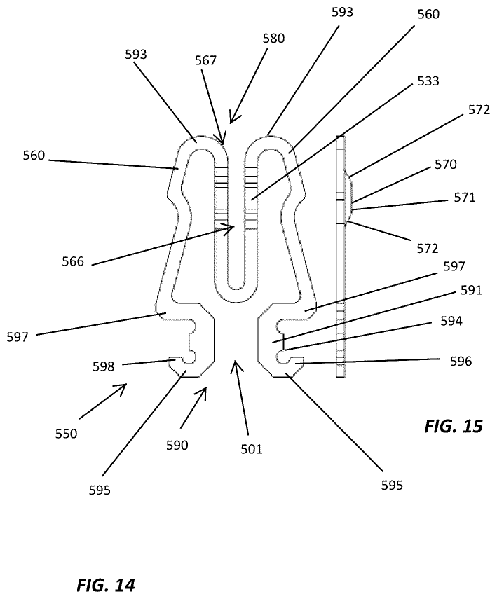

As depicted in FIGS. 14-15, a connector 550 may be identical to connector 450 described above except that connector 450 may include a groove 566 which is linear along a length thereof (i.e., in contrast to linear portion 434 and rounded portion 435 of groove 466) bounded by inner surfaces of a center arm 533. Further, a tab 570 may have a shape different from tab 470. In particular, tab 570 may include ramped portions 572 at opposite longitudinal ends connected by a flattened portion 571. As described above relative to tab 470, tab 570 may be formed of upwardly extending portions of center arm 533.

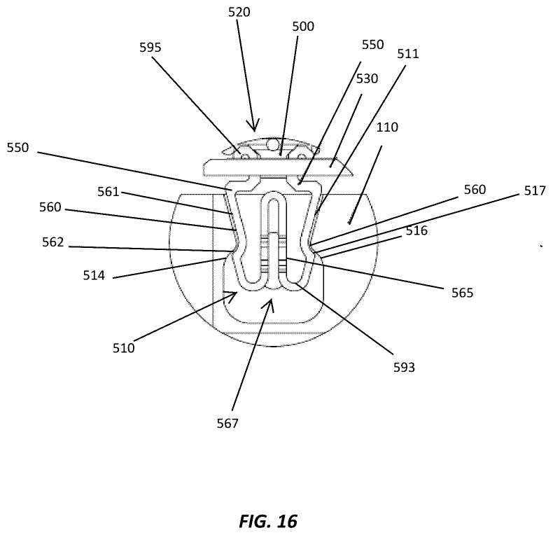

FIG. 16 depicts connector 550 being connected to a fuel cell plate, such as plate separator 110 or plate separator 160, for example, and a pickup card 530 similar to pickup card 330 described above.

In an example, connector 550 may be received in a slot 510 of plate separator 110 such that connector 550 makes an electric connection with the plate separator. Such an electrical connection may allow a voltage measurement between two fuel cell plates, such as plate separator 110 and a second plate separator (e.g., plate separator 160) also electrically connected to a voltage sensor. Slot 510 may include vertical slot bounding surfaces (not shown but similar to surfaces 211 and 212), and lateral slot bounding surfaces 514 and 516. The portions of the plate separators bounding the slots and the electrical connectors (e.g., connector 550) may be formed of, or otherwise include an electrically conductive material to allow connection to a voltage sensor, other measuring instrument, controller, or electrical device as indicated above.

For example, connector 550 may be formed of a stamped sheet metal (e.g., Copper, Nickel, Stainless Steel, Titanium, Monel, Inconel, or other alloys of such materials therein that are both conductive and inert whether through plating or passive formation of protection that does not impede electrical operation or solderability). Outer arms 560 may be elastically deformable (e.g., via hand manipulation by a user) toward one another and a center arm 565 and/or center arm portions 533 may be deformable into a groove 533 bounded by inner surfaces of center arm portions 533, such that outer arms 360 may be inserted into and received in a slot (e.g., slot 510). Outer arms 560 and/or center arm portions 533 may elastically return such that outer arms 560 contact lateral slot bounding surfaces (e.g., lateral slot bounding surfaces 514, 516) of the slot (e.g., slot 510). A contact of outer surfaces of outer arms 560 with such lateral slot bounding surfaces may inhibit a removal of connector 550 from the slot. As depicted, outer arms 560 may include proximal portions 561 having axes angled (e.g., inwardly toward the axis of connector 550) relative to a longitudinal axis of connector 550 to be complementarily shaped relative to proximal portions 511 of lateral slot bounding surfaces 514, 516. Further, outer arms 560 may include shoulders 562 extending at an angle (e.g., outwardly away from the axis of connector 550) relative to proximal portions 511 and distal portions 513 extending inwardly. For example, after an insertion of connector 550 into a slot (e.g., slot 510) outer arms may elastically return such that distal portions 513 are received in lateral recesses 515 of the slot and shoulders may extend laterally past a shoulder engaging surface 517 of bounding surface 516, for example. Shoulders 562 may thus engage shoulder engaging surface 517 to inhibit retraction and removal of connector 550 from the slot (e.g., slot 510) if a retractive force were applied to connector 550.

Further, a reverse of the above described insertion procedure may be applied to a connector (e.g., connector 550) to remove the connector from a slot (e.g., slot 510) of a fuel cell plate (e.g., plate separator 110). For example, a force may be applied to outer arms 560 to deform them toward one another such that shoulders may be located at a point close enough to the axis of connector 550 such that connector 550 may be retracted from the slot without shoulders 562 contacting shoulder engaging surface 517 or an opposite shoulder engaging surface of bounding surface 514.

Connecting arms 595 of a proximal end 590 of connector 550 opposite a distal end 580 thereof may be elastically deformable (e.g., via hand manipulation by a user) toward one another such that connecting arms 595 may be received in a card slot 510 bounded by surfaces of an electrical device, such as pickup card 530, for example, as depicted in FIG. 16. Connecting arms 595 may be connected to outer arms 560 at connecting intersections 597 as depicted in FIG. 14. Such elastic deformation of connecting arms 595 may occur with outer arms 560 connected thereto and may be relative to pivot points at curved connecting intersections 593 between outer arms 560 and center arm portions 533, such that connecting arms 595 move toward each other about such pivot points. Center arm portions 533 may also deform toward each other (e.g., into groove 566) to allow connecting arms 595 (and outer arms 560) to move toward each other enough to allow an insertion of connector 550 into a slot (e.g., slot 510) in a direction about perpendicular to such movement. For example, a deformation of center arm portions 533 at a distal end 567 of groove 566 adjacent curved connecting intersections 593 may facilitate such deformation and/or movement of connecting arms 595 toward each other.

For example, arms 595 may be deformed toward each other to allow the arms to be received in such a slot (e.g., slot 320, slot 520) and the arms may be released such that they elastically return and contact interior surfaces (e.g., interior surfaces 315 of slot 310) and/or a back surface (e.g., a back surface 505) of the card (e.g., card 530) bounding the slot, such that the arms (e.g., connecting arms 595) may inhibit separation of connector 550 from the card. For example, connecting arms 595 may extend laterally or vertically past a side of the surfaces bounding the opening (e.g., of slot 320, slot 520)) such that the arms may contact the interior surface(s) and/or the exterior surface(s) of the card to inhibit the separation of the connector 550 from the card.

Further, as depicted in FIGS. 14-16, each of arms 595, similar to arms 495 described above, may include a leg portion 591 with a flat external surface 594 and a hooked or pronged portion 596 at a proximal end thereof but extending distally. Ends 598 of arms 595 may contact an interior (not shown) or exterior surface (e.g., back surface 505) of a card (e.g., card 530) to inhibit separation of connector 550 from the card.

A snap or friction lock 500 may be designed and optimized (e.g., shaped, dimensioned, and material selected) to be inserted into an opening 501 at proximal end 590 of connector 550 between and contacting arms 595 to inhibit movement of arms 595 toward each other and thus a separation of connector 550 from card 550 as depicted in FIG. 16. For example, lock 500 may be frictionally fit between arms 595 to inhibit movement of arms 595 toward each other. In another example, a push in rivet or snap lock pin may be utilized in place of lock 500.

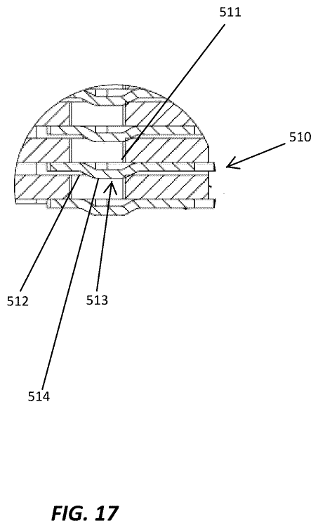

In an example, FIG. 17 depicts a side cross-sectional view of a plurality of connectors (e.g., instances of connector 550) having tabs (e.g., tab 570) received in receiving recesses of a plurality of slots (e.g., slots 210, 510) of fuel cell plates (e.g., instances of plate separators 110, 160). The plurality of connectors (e.g. instances of connector 550) may be installed individually into the recesses of a plurality of slots (e.g., slots 210, 510) of fuel cell plates (e.g., instances of plate separators 110, 160) or installed in a plurality of slots (e.g. 310) first in the receiving pickup card (e.g. 530) to be installed into the recesses of a plurality of slots simultaneously.

For example, surfaces bounding a slot (e.g., slot 510) may include a recess for receiving tab 570. A slot (e.g., slot 510) may receive, and connector 550 may be dimensioned such that, tab 570 may be received therein, and may be elastically deformed such that, tab 570 may elastically return (e.g., in a direction perpendicular to a longitudinal dimension of the slot) to be received in the recess of the slot. After being received in the recess, tab 570 may contact surfaces bounding the recess such that these surfaces contacting the tab may inhibit removal of the tab from the recess. Tab 570 may additional be used to locate the connector at a desired position within the slot (e.g., slot 510. As depicted in FIG. 17, slot 510 of a fuel cell plate (e.g., plate separator 110), may be one of a plurality of slots and may include a top slot bounding surface 511 and a bottom slot bounding surface 512. Bottom slot bounding surface 512 may include a recess 513 near a distal end thereof which may be configured (e.g., shaped and dimension) to receive a tab (e.g., tab 570) of a connector, such as connector 550. For example, connector 550 may be inserted into slot 510 such that tab 570 make elastically deform upwardly while in contact with top slot bounding surface 511 and bottom slot bounding surface 512 until tab 570 reaches recess 513—at which time tab 570 may elastically return to be received in recess 513 bounded by surfaces 514 of bottom slot bounding surface 512 and thereby provide a frictional fit inhibiting backward movement of connector 550 out of slot 510.

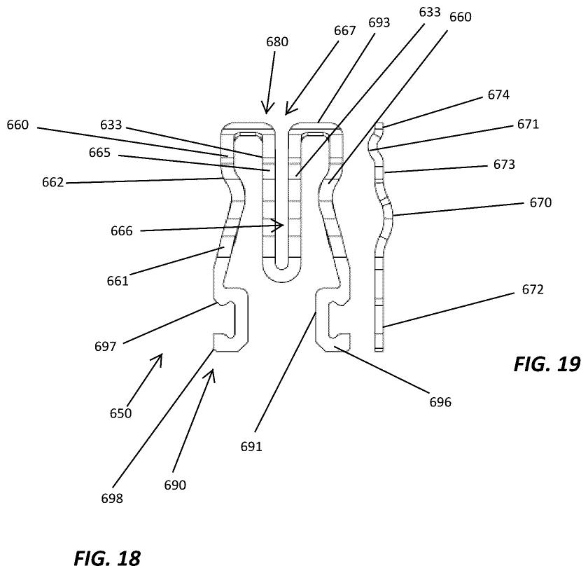

As depicted in FIGS. 18-19, a connector 650 may be similar to connector 550 described above except that connector 550 may include a square shaped intersection 693 instead of curved connecting intersections 593 at a distal end 680 thereof. Further, a cross-sectional shape of connector 650 may differ from connector 550 as is evident comparing FIG. 19 to FIG. 15.

Connector 650 may include a groove 666 similar to groove 566 of connector 550 which is linear along a length thereof and bounded by inner surfaces of a center arm 665. Further, a tab 670 may have a shape different from tab 570. As indicated, a cross-sectional shape of connector 650 may include tab 670 and a distal tab 671 extending in opposite directions relative to a longitudinal axis of connector 650. A linear portion 672 may be located at a proximal end 690 of connector 650 and may connect to tab 670 which curves downwardly and connects to a second linear portion 673 which connects to distal tab 671 which connect to a straightened end 674.

In an example, connector 650 may be received in a slot (e.g., slot 510) of a fuel cell plate (e.g., plate separator 110), such that connector 650 makes an electrical connection with the plate separator as described above relative to connector 550. Such an electrical connection may allow a voltage measurement between two fuel cell plates, such as plate separator 110 and a second plate separator (e.g., plate separator 160) also electrically connected to a voltage sensor.

For example, connector 650 may be formed of a stamped sheet metal (e.g., Copper, Nickel, Stainless Steel, Titanium, Monel, Inconel, or other alloys of such materials therein that are both conductive and inert whether through plating or passive formation of protection that does not impede electrical operation or solderability. Outer arms 660 may be elastically deformable (e.g., via hand manipulation by a user) toward one another and center arm 665 and/or center arm portions 633 may be deformable into groove 666 bounded by inner surfaces of center arm portions 633, such that outer arms 660 may be inserted into and received in a slot (e.g., slot 510) as described above for connector 550. Outer arms 660 and/or center arm portions 633 may elastically return such that outer arms 660 contact lateral slot bounding surfaces (e.g., lateral slot bounding surfaces 514, 516) of a slot (e.g., slot 510). A contact of outer surfaces of outer arms 660 with such lateral slot bounding surfaces may inhibit a removal of connector 650 from such a slot. As depicted, outer arms 660 may include proximal portions 661 having axes angled (e.g., inwardly toward the axis of connector 650) relative to a longitudinal axis of connector 650 to be complementarily shaped relative to proximal portions 511 of lateral slot bounding surfaces 514, 516 of slot 510 (FIG. 16), if connector 660 were received therein, for example. Further, outer arms 660 may include shoulders 662 extending at an angle (e.g., outwardly away from the axis of connector 650) relative to proximal portions 661. For example, after an insertion of connector 650 into a slot (e.g., slot 510) outer arms may elastically return such that distal portions 613 are received in lateral recesses 515 of the slot and shoulders may extend laterally past a shoulder engaging surface 517 of bounding surface 516, for example. Shoulders 662 may thus engage shoulder engaging surface 517 to inhibit retraction and removal of connector 650 from the slot (e.g., slot 510) if a retractive force were applied to connector 650, as described above relative to connector 550.

Connecting arms 695 of proximal end 690 of connector 650 opposite a distal end 680 thereof may be elastically deformable (e.g., via hand manipulation by a user) toward one another such that connecting arms 695 may be received in a card slot 510 (FIG. 16) bounded by surfaces of a pickup card 530, for example, as described above relative to connector 550. Connecting arms 695 may be connected to outer arms 660 at connecting intersections 697 as depicted in FIG. 18. Such elastic deformation of connecting arms 695 may occur with outer arms 660 connected thereto and may be relative to pivot points at curved connecting intersections 693 between outer arms 660 and center arm portions 633, such that connecting arms 695 move toward each other about such pivot points. Center arm portions 633 may also deform toward each other (e.g., into groove 666) to allow connecting arms 695 (and outer arms 660) to move toward each other enough to allow an insertion of connector 650 into a slot (e.g., slot 510, FIG. 16) in a direction about perpendicular to such movement. For example, a deformation of center arm portions 633 at a distal end 667 of groove 666 adjacent curved connecting intersections 693 may facilitate such deformation and/or movement of connecting arms 695 toward each other.

For example, arms 695 may be deformed toward each other to allow the arms to be received in such a slot (e.g., slot 320, slot 520) and the arms may be released such that they elastically return and contact interior surfaces (e.g., interior surfaces 315 of slot 320) and/or a back surface (e.g., a back surface 505) of the card (e.g., card 530) bounding the slot, such that the arms (e.g., connecting arms 595) may inhibit separation of connector 650 from the card. For example, connecting arms 695 may extend laterally or vertically past a side of the surfaces bounding the opening (e.g., of slot 320, slot 520) such that the arms may contact the interior surface(s) and/or the exterior surface(s) of the card to inhibit the separation of the connector 650 from the card.

Further, as depicted in FIGS. 18-19, each of arms 695, similar to arms 595 described above, may include a leg portion 691 and a perpendicularly returning arm 696. Unlike arms 595, arms 695 do not include a flat external surface like flat external surface 594 (FIG. 14) nor a hooked or pronged portion like hooked or pronged portion 596 (FIG. 14). Ends 698 of arms 695 may contact an interior (not shown) or exterior surface (e.g., back surface 505) of a card (e.g., card 530) to inhibit separation of connector 650 from the card.

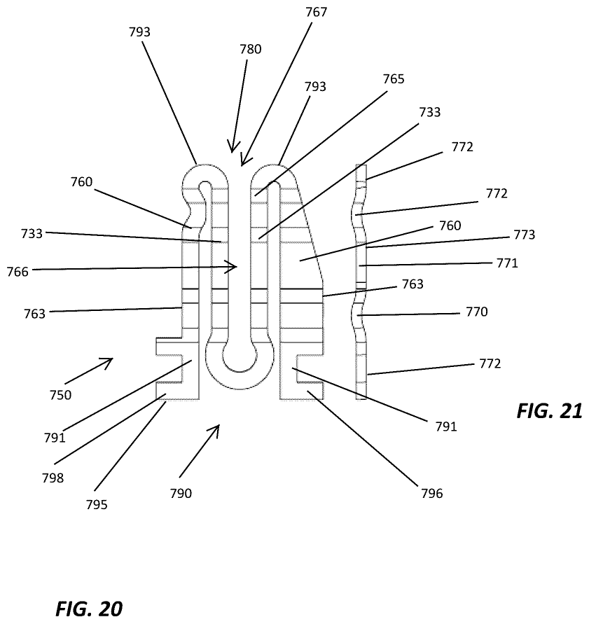

As depicted in FIGS. 20-21, a connector 750 may have a center groove 766 similar to connector 550 and connector 650. Outer arms 760 may be asymmetrical in contrast to those of the other connectors described above. Groove 766 may be linear along a length thereof and bounded by inner surfaces of a center arm 765. Outer surfaces 763 may be configured (e.g., shaped and dimensioned) to be received in a slot having complementary surfaces to allow a deformation toward each other, and return, of outer arms 760 and/or center arm portions 733 to allow an insertion into a slot similar to that described above for connectors 550 and 650, and slot 510, for example.

As depicted in FIG. 21, a cross-sectional shape of connector 750 may include a curved tab 770 and a curved distal tab 771 extending in a same direction relative to a longitudinal axis of connector 750. Linear portions 772 may be located at a proximal end 790, a distal end 780, and a central portion 773 between tab 770 and tab 771 of connector 650. As described above, connector 750 may be configured (e.g., shaped and dimensioned) to various thicknesses and widths in such a way as to limit deformation and motion laterally or vertically in a slot of a fuel cell plate, dependent on the geometry of the receiving slot feature of the plate. Larger cross sections equate to reduced deflection and improved planar stability, whereas thinner cross sections enable more deflection and lower insertion force. The vertical bends (e.g., curved tab 770 and a curved distal tab 771) allow for additional retention force as compared to a linear version of such a connector.

Connecting arms 795 of proximal end 790 of connector 650 opposite distal end 780 thereof may be elastically deformable (e.g., via hand manipulation by a user) toward one another such that connecting arms 795 may be received in a slot, such as connector 550 being received in card slot 520 (FIG. 16) of pick up card 530, as described above, for example. Such elastic deformation of connecting arms 795 may occur with outer arms 760 connected thereto and may be relative to pivot points at curved connecting intersections 793 between outer arms 760 and center arm portions 733, such that connecting arms 795 move toward each other about such pivot points. Center arm portions 733 may also deform toward each other (e.g., into groove 766) to allow connecting arms 795 (and outer arms 760) to move toward each other enough to allow an insertion of connector 750 into a slot (e.g., slot 510, FIG. 16) in a direction about perpendicular to such movement. For example, a deformation of center arm portions 733 at a distal end 767 of groove 766 adjacent curved connecting intersections 793 may facilitate such deformation and/or movement of connecting arms 795 toward each other.

For example, arms 795 may be deformed toward each other to allow the arms to be received in such a slot (e.g., slot 320, slot 520) and the arms may be released such that they elastically return and contact interior surfaces (e.g., interior surfaces 315 of slot 320) and/or a back surface (e.g., a back surface 505) of the card (e.g., card 530) bounding the slot, such that the arms (e.g., connecting arms 795) may inhibit separation of connector 750 from the card. For example, connecting arms 795 may extend laterally or vertically past a side of the surfaces bounding the opening (e.g., of slot 320, slot 520) such that the arms may contact the interior surface(s) and/or the exterior surface(s) of the card to inhibit the separation of connector 750 from the card.

Further, as depicted in FIGS. 20-21, each of arms 795, similar to arms 695 described above, may include a leg portion 791 and a perpendicularly returning arm 796. Ends 798 of arms 795 may contact an interior (not shown) or exterior surface (e.g., back surface 505) of a card (e.g., card 530) to inhibit separation of connector 750 from the card.

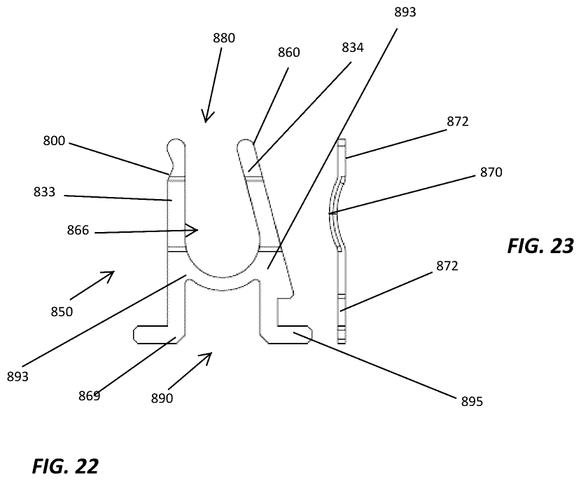

As depicted in FIGS. 22-23, a connector 850 may have arms 860 bounding a space 866 therebetween. Arms 860 may include a first arm 833 having a longitudinal axis extending parallel to a longitudinal axis of connector 850 and a second arm 834 having a longitudinal axis extending toward first arm 833. A curved bottom portion 869 may connect first arm 833 and second arm 834.

Connecting arms 895 of a proximal end 890 of connector 850 opposite a distal end 880 thereof may be elastically deformable (e.g., via hand manipulation by a user) toward one another such that connecting arms 895 may be received in a slot, such as connector 550 being received in card slot 520 (FIG. 16) of pick up card 530, as described above, for example. Such elastic deformation of connecting arms 895 may occur with arms 860 connected thereto and may be relative to pivot points at intersections 893 between arms 860 and connecting arms 895, such that connecting arms 895 move toward each other about such pivot points. Arms 860 may also deform toward each other to allow arms 860 to move toward each other enough to allow an insertion of connector 850 into a slot (e.g., slot 510, FIG. 16) in a direction about perpendicular to such movement, as described above for connectors, such as connector 750 and connector 650, for example. In an example, space 866 could receive an obstacle or projection in a slot to allow a remainder of connector 850 to be received in a slot but around such an obstacle. Arms 860 could also be elastically deformable away from each other to allow connector 850 to receive such an obstacle in space 866 while being received in such a slot. As also is evident from FIG. 22, arms 860 are asymmetric to allow connector 850 to be received in complementarily shaped asymmetrical slot.

A cross-sectional shape of connector 850 may include a curved tab 870 and linear portions 872 may be located at proximal end 890 and distal end 880 thereof. As described above, a tab (e.g., tab 870) may provide a frictional fit against slot bounding surfaces of a slot (such as described above for slots 210, 310, and 510 having shapes complementary to connectors described above) and/or may be received in a recess of such a slot and resist a retraction of a connector (e.g., connector 850) when the connector is received in the slot and the tab is received (e.g., via an elastic return) in such a recess.

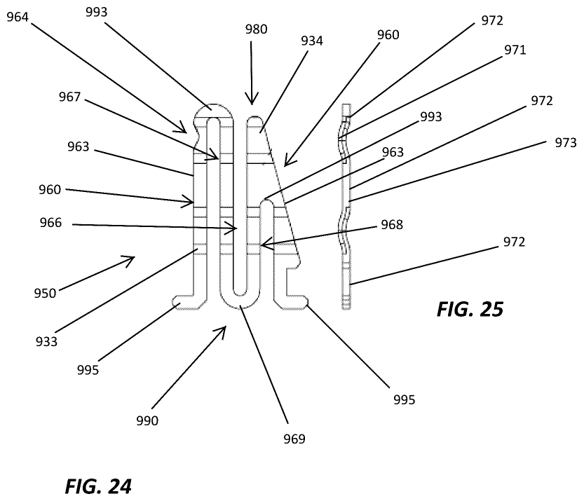

As depicted in FIGS. 24-25, a connector 950 may have arms 960 bounding a groove 966 therebetween. Arms 960 may include a first arm 933 and a second arm. First arm 933 and second arm 934 may have inner surfaces bounding groove 966 which may extend from near a proximal end 990 to a distal end 980 thereof. A curved bottom portion 969 may connect first arm 933 and second arm 934.

Connecting arms 995 of proximal end 990 of connector 950 opposite distal end 980 thereof may be elastically deformable (e.g., via hand manipulation by a user) toward one another such that connecting arms 995 may be received in a slot, such as connector 550 being received in card slot 520 (FIG. 16) of pick up card 530, as described above, for example. Such elastic deformation of connecting arms 995 may occur with arms 960 connected thereto and may be relative to pivot points at intersections 993 at opposite ends of second groove 967 and third groove 968 bounded by inner surfaces of first arm 933 and second arm 934, respectively. Connecting arms 995 move toward each other about such pivot points. Arms 960 may also deform toward each other (e.g., toward and/or into groove 966) to allow arms 960 to move toward each other enough to allow an insertion of connector 950 into a slot (e.g., slot 510, FIG. 16) in a direction about perpendicular to such movement, as described above for connectors, such as connector 750 and connector 650, for example.

Outer surfaces 963 of arms 960 may be configured (e.g., shaped and dimensioned) to be received in a slot having complementary surfaces such that a deformation toward each other, and elastic return, of arms 960 allow an insertion into a slot and complementarily aligned surfaces similar to that described above for connectors 550 and 650, and slot 510, for example. A notch 964, for example, may engage with a slot bounding surface of a slot of a fuel cell such that after arms 960 are moved toward each other, the arms may be returned such that notch 964 may receive a projection of the slot bounding surface such that a retraction of connector 850 from the slot may be inhibited. Further, such a movement of arms 960 toward each other may occur via deformation of one of intersections 993 closest to notch 964 and/or end 969 connecting first arm 933 and second arm 934.

As depicted in FIG. 25, a cross-sectional shape of connector 950 may include a curved tab 970 and a curved distal tab 971 extending in a same direction relative to a longitudinal axis of connector 950. Linear portions 972 may be located at proximal end 990, distal end 780, and a central portion 973 between tab 970 and tab 971 of connector 950.

As described above. a connector (e.g., connectors 250, 350, 450, 550, 650, 750, 850, 950) could be formed in various shapes to allow the connector to be deformed and inserted into a slot such that an elastic return causes the connector to be located such that portions of the connector inside such a slot inhibit a retraction of the connector from the slot. Further such connectors could be formed of various materials and thicknesses to allow the connectors to be shaped complementarily to a slot in which it is received to inhibit removal therefrom once the connector in inserted. Such materials and thicknesses may be selected to promote elastic deformation and frictional fits as described above The connector could have deformable arms on multiple ends (e.g., proximal and distal ends thereof) to allow the connector to be received in multiple slots to allow an electrical connection between fuel cell plates, pick up cards, printed circuit boards, sensors, controllers or other electrical devices having openings with surfaces bounding such openings that may be allow an electrical connection when elastically returnable portions of a connector contact such slot bounding surfaces to provide a mechanical connection between such devices. The connectors described above may have various portions allowing such elastic deformation including arms movable about pivot points and grooves and openings into which portions of such connectors may be movable and/or elastically deformable into.

While several aspects of the present invention have been described and depicted herein, alternative aspects may be affected by those skilled in the art to accomplish the same objectives. Accordingly, it is intended by the appended claims to cover all such alternative aspects as being within the true spirit and scope of the invention.

1. A connector system for use in connecting a fuel cell plate to an electrical device, the system comprising:
first arms elastically deformable toward each other to allow an insertion of said first arms into a first slot of a fuel cell plate and elastically returnable to provide a force against a surface of said fuel cell plate to hold said arms against said fuel cell plate;
second arms elastically deformable toward each other to allow an insertion of said second arms into a second slot of an electrical device and elastically returnable to provide a force against a surface of said electrical device to hold said arms against said electrical device; and
said first arms connected to said second arms at intersecting points allowing movement of said first arms relative to said second arms.

2. The system of claim 1 further comprising a center arm between said first arms and connected to said first arm and/or said second arm, said center arm having a distal arm end for insertion of said distal arm end into said slot, and said center arm extending from said distal arm end toward said second arms at a proximal end of said connector.

3. The system of claim 1 further comprising a center arm between said first arms, said center arm comprising inner portions bounding a space, said inner portions movable into said space to allow the first arms to be elastically deformed toward each other and/or the second arms to be elastically deformed toward each other.

4. The system of claim 1 further comprising a longitudinal axis extending between a first end and a second end, said first arms located at said first end and said second arms located at said second end, and wherein said first arms are elastically deformable toward each other in a transverse direction relative to said longitudinal axis to allow the insertion of the first arms into the slot.

5. The system of claim 1 further comprising a longitudinal axis extending between a first end and a second end, said first arms located at said first end and said second arms located at said second end, and wherein said second arms are elastically deformable toward each other in a transverse direction relative to said longitudinal axis to allow the insertion of the second arms into the second slot.

6. The system of claim 1 further comprising a longitudinal axis extending between a first end and a second end, wherein said second arms comprise linear portions extending parallel to said longitudinal axis and transverse portions extending from said linear portions away from said longitudinal axis.

7. The system of claim 1 further comprising a tab projecting in a transverse direction relative to a longitudinal axis of said first arms, said tab elastically deformable toward the axis and elastically returnable to provide a frictional fit against slot bounding surfaces of the first slot of the fuel cell plate when the first arms are elastically deformed to insert said first arms into the first slot of the fuel cell plate.

8. The system of claim 1 wherein said first arms are located in a first plane and further comprising a tab projecting in a transverse direction relative to a longitudinal axis of said first arms and outside said first plane, said tab elastically deformable toward said first plane in response to said tab contacting slot bounding surfaces of the first slot of the fuel cell plate, and said tab elastically returnable to provide a frictional fit against said slot bounding surfaces.

9. The system of claim 1 further comprising a center arm between said first arms and connected to said first arm and/or said second arm, said center arm having a distal arm end for insertion of said distal arm end into said slot, and said center arm extending from said distal arm end toward said second arms at a proximal end of said connector, said first arms and said center arm comprising a tab projecting in a transverse direction relative to a longitudinal axis of said first arms, said tab elastically deformable and elastically returnable to provide a frictional fit against slot bounding surfaces of the first slot of the fuel cell plate when the first arms are elastically deformed to insert said first arms into the first slot of the fuel cell plate.

10. The system of claim 1 further comprising a center arm between said first arms and connected to said first arm and/or said second arm, and said center arm comprising a tab projecting in a transverse direction relative to a longitudinal axis of said center arm and in a thickness direction of said connector, said tab elastically deformable toward the axis and elastically returnable to provide a frictional fit against slot bounding surfaces of the first slot of the fuel cell plate when the first arms are elastically deformed to insert said first arms into the first slot of the fuel cell plate.

11. The system of claim 1 wherein said first arms comprise a distal end opposite a proximal end of said second arms, said proximal end and said distal end having longitudinal axes which are aligned and further comprising a tab between said proximal end and said distal end having a tab longitudinal axis unaligned relative to said axes of said proximal end and said distal end, said tab being elastically deformable toward a connector axis connecting said longitudinal axes of said proximal end and said distal end to provide a frictional fit against slot bounding surfaces of the first slot of the fuel cell plate when the distal end is inserted into the first slot of the fuel cell plate.

12. A method for connecting a fuel cell plate to an electrical device, the method comprising:
elastically deforming first arms of a connector toward each other, inserting the first arms into a first slot of a fuel cell plate and releasing the first arms to elastically return the first arms to engage first surfaces of the fuel cell plate to connect the first arms to the fuel cell plate; and
elastically deforming second arms of the connector toward each other, inserting the second arms into a second slot of an electrical device to electrically connect the fuel cell plate to the electrical device, and releasing the second arms to elastically return the second arms to engage second surfaces of the electrical device to connect the second arms to the second device.

13. The method of claim 12 wherein the elastically deforming the first arms comprises elastically deforming the first arms about pivot points connecting the first arms to the second arms.

14. The method of claim 12 wherein the elastically deforming the first arms comprises elastically deforming the first arms toward a space of a center arm connected to the first arms and/or the second arms.

15. The method of claim 12 wherein the elastically deforming the first arms comprises deforming center arms into a groove bounded by the center arms, the center arms connected to the first arms and/or the second arms.

16. The method of claim 12 wherein the elastically deforming the second arms comprises deforming center arms into a groove bounded by the center arms, the center arms connected to the first arms and/or the second arms.

17. The method of claim 12 wherein the connector comprises a tab projecting in a transverse direction relative to a longitudinal axis of said first arms, and further comprising elastically deforming the tab toward the axis to provide a frictional fit against slot bounding surfaces of the first slot of the fuel cell plate.

18. The method of claim 17 further comprising locating the tab at a recess of the slot bounding surfaces and the tab elastically returning into the recess to provide a second frictional fit between recess bounding surfaces of the recess and the tab.

19. The method of claim 12 wherein the engaging the first surfaces comprises the first arms contacting first inner surfaces of the first slot to provide a frictional fit of the first arms with the first inner surfaces.

20. The method of claim 12 wherein the engaging the second surfaces comprises the second arms contacting second inner surfaces of the second slot to provide a frictional fit of the second arms with the second inner surfaces.

21. The method of claim 12 wherein the engaging the second surfaces comprises the second arms extending through the second slot, contacting second inner surfaces of the second slot, and contacting external surfaces of the electrical device on an opposite side of said second slot relative to said fuel cell plate.

22. A fuel cell system comprising:
a membrane electrode assembly;
a first fuel cell plate separator and a second fuel cell plate separator on opposite sides of said membrane electrode assembly;
a connector for connecting to said first fuel cell plate separator and an electrical device connected to said second fuel cell plate separator;
said connector comprising a first end elastically deformable and received in a first slot of said first plate separator, such that said first end contacts first slot bounding surfaces bounding said first slot in response to an elastic return of said first end after said connector is elastically deformed to be received in said slot, said connector held in said first slot by a force provided by said first end against said first slot bounding surfaces by the elastic return;
said connector comprising a second end elastically deformable and received in a second slot of said electrical device, such that said second end contacts said electrical device in response to a second elastic return of said second end after said connector is elastically deformed to be received in said second slot, said connector held in said second slot by a force provided by said second end against said electrical device by the second elastic return.
